(19) United States
(12) Patent Application Publication
(10) Pub. No.: US 2008/0099394 A1
(43) Pub. Date: May 1, 2008

(54) Distributor assembly for pressure vessel and method of installation

(76) Inventors: Kemp Falkner, St. Augustine, FL (US); Chris Kampf, Johnston, RI (US)

Correspondence Address: EDWARDS ANGELL PALMER & DODGE LLP, P.O. BOX 55874, BOSTON, MA, 02205, US

(21) Appl. No.: 11/726,945

(22) Filed: Mar. 23, 2007

Related U.S. Application Data
(60) Provisional application No. 60/785,020, filed on Mar. 23, 2006.

(51) Int. Cl. B01D 17/12; B01D 17/00

(52) U.S. Cl. 210/600; 137/599.12; 210/120; 210/137

(57) ABSTRACT

The invention provides a fluid distributor and associated water treatment system. The system includes a pressure vessel adapted and configured to hold a predetermined volume of fluid and a fluid distribution assembly. The fluid distribution assembly is preferably disposed at a lower end of the pressure vessel, and includes a water inlet manifold adapted and configured to direct water from an upstream location into a vessel that the distributor assembly is mounted into, a water outlet manifold adapted and configured to direct water from the vessel to a downstream location and an air volume control valve adapted and configured to maintain a predetermined pressure range in the vessel.

### CROSS-REFERENCE TO RELATED APPLICATION

This application claims the benefit of priority from U.S. Provisional Patent Application Ser. No. 60/785,020 filed Mar. 23, 2006, the disclosure of which is incorporated by reference herein in its entirety.

### BACKGROUND OF THE INVENTION

1. Field of the Invention

The present invention relates to a fluid distribution assembly for a pressure vessel. Particularly, the present invention is directed to a fluid distribution assembly for a fluid pressure vessel.

2. Description of Related Art

A variety of devices are known in the art for distributing fluids within pressure vessels. For example, in U.S. Pat. No. 6,080,306, which is incorporated herein by reference in its entirety, a fluid distribution system is provided wherein liquid water is introduced and removed from a pressure vessel by way of a lower distribution assembly disposed proximate the bottom of the pressure vessel, while air pressure in the pressure vessel is maintained by an air volume control assembly disposed proximate the top of the pressure vessel. Another system having a water distribution assembly proximate the bottom of the tank and an air volume control assembly proximate the top of the tank is also presented in U.S. Pat. No. 6,481,456, which is also incorporated by reference herein in its entirety. Air can be introduced into such systems by entraining it into the fluid stream before it enters the tank using devices described, for example, in U.S. Pat. No. 7,125,003, which is incorporated by reference herein in its entirety.

While such conventional methods and systems generally have been considered satisfactory for their intended purpose, there is a continued need in the art for fluid distribution assemblies, such as for pressure vessels, that are reliable, inexpensive, easy to make and install. The present invention provides a solution for these and other problems.

### SUMMARY OF THE INVENTION

The purpose and advantages of the present invention will be set forth in and become apparent from the description that follows. Additional advantages of the invention will be realized and attained by the methods and systems particularly pointed out in the written description and claims hereof, as well as from the appended drawings.

To achieve these and other advantages and in accordance with the purpose of the invention, as embodied herein, the invention includes a fluid distribution assembly for a pressure vessel including a liquid distribution assembly portion and a gaseous distribution assembly portion that are adapted and configured to be introduced proximate a single location of the pressure vessel, such as the bottom of a pressure vessel.

The accompanying drawings, which are incorporated in and constitute part of this specification, are included to illustrate and provide a further understanding of the method and system of the invention. Together with the description, the drawings serve to explain the principles of the invention.

### BRIEF DESCRIPTION OF THE DRAWINGS

FIGS. 1(a)-1(c) include schematic views of a vessel including a first representative embodiment of a distribution assembly made in accordance with the present invention and associated water treatment system.

FIG. 2 is a first schematic side view of the distribution assembly depicted in FIG. 1.

FIG. 3 is a second schematic side view of the distribution assembly depicted in FIG. 1.

FIG. 4 is a schematic top view of the distribution assembly depicted in FIG. 1.

FIG. 5 is an exploded view of the distribution assembly depicted in FIG. 1.

FIG. 6 is a partial view of the distribution assembly depicted in FIG. 1 showing water flow paths.

FIG. 7 is a partial cutaway view of the distribution assembly depicted in FIG. 1 showing water flow paths.

### DETAILED DESCRIPTION OF THE PREFERRED EMBODIMENT

Reference will now be made in detail to the present preferred embodiments of the invention, an example of which is illustrated in the accompanying drawings. The method and corresponding steps of the invention will be described in conjunction with the detailed description of the system.

The devices and methods presented herein may be used for distributing fluids in a pressure vessel. Particularly, the present invention is useful for distributing fluids in a pressure vessel used for water treatment.

In accordance with the invention, a fluid distributor assembly for a pressure vessel is provide.

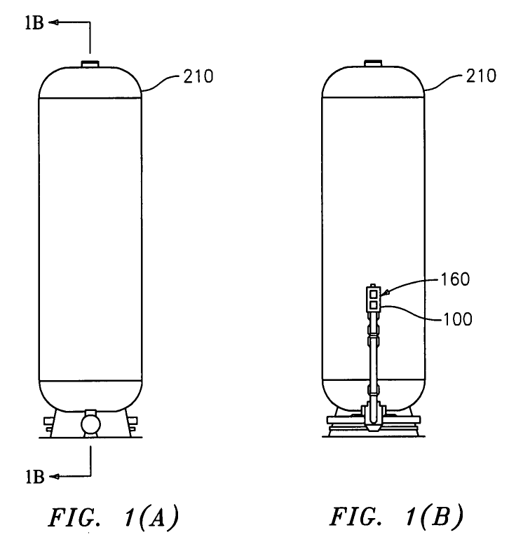

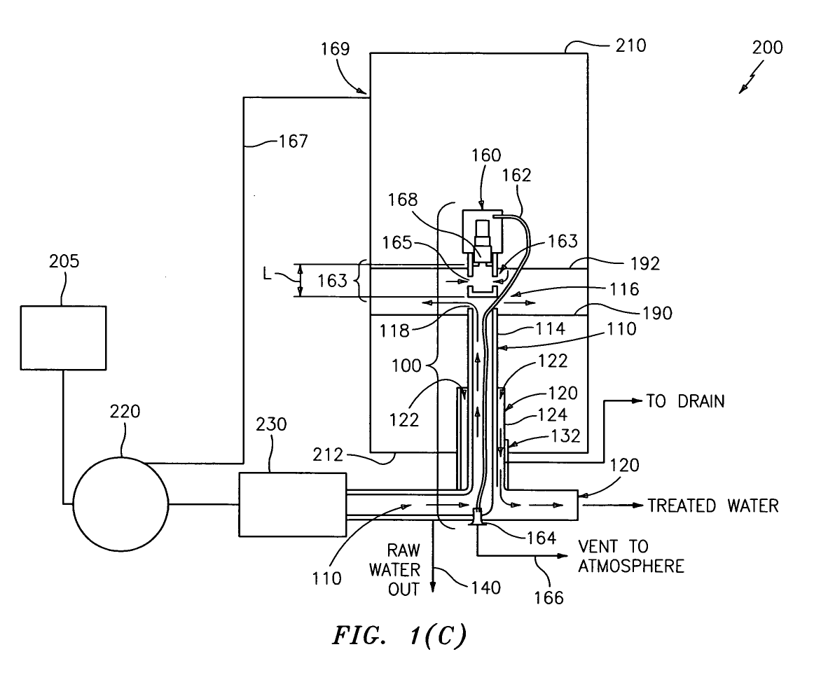

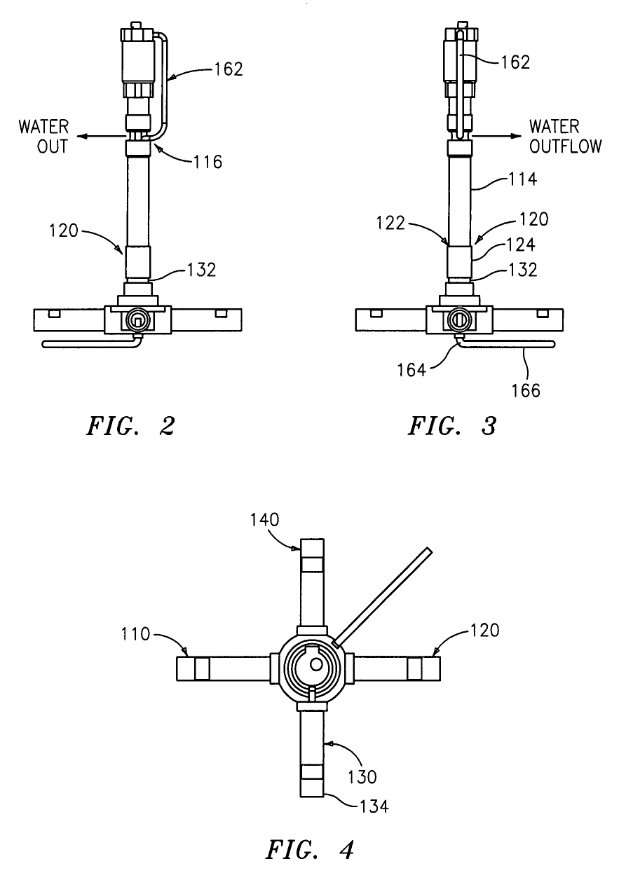

For purpose of explanation and illustration, and not limitation, views of an exemplary embodiment of the fluid distributor assembly provided in accordance with the invention are shown in FIGS. 1-7 and are designated generally by reference character 100.

As disclosed in FIG. 1(c), a fluid distributor assembly 100 is intended to be used as a portion of a larger water treatment system 200, such as a system for removing hydrogen sulfide from potable water. Such systems are described, for example, in U.S. Pat. No. 6,080,306 and U.S. Pat. No. 6,481,456. Water treatment system 200 includes, for example, a water treatment tank 210 in fluid communication with an upstream pump 220 that directs water from a water source 205, such as a well, river, lake or the like. An air inductor 230 is provided that may be similar to that described in U.S. Pat. No. 7,125,003 for entraining air into the water flow to facilitate treatment of the water. Tank 210 may be metallic, but is preferably a fiber wound plastic tank made in accordance with the teachings presented in U.S. patent application Ser. No. 11/540,189 filed Sep. 29, 2006, which is incorporated by reference herein in its entirety.

As depicted, for example, in FIGS. 1-5, distributor assembly 100 is adapted and configured to introduce air and water into a vessel such as vessel 210, or other suitable vessel. While distributor assembly 100 is depicted as being installed through the bottom of a vessel 212 it will be understood that other suitable arrangements are possible (e.g., top or side mounting), depending on the particular application.

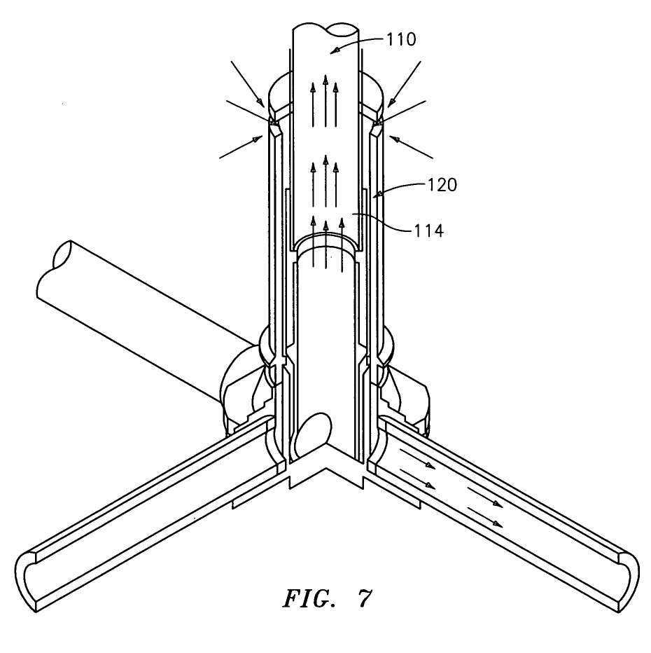

As depicted, distributor assembly 100 includes a water inlet manifold 110 adapted and configured to direct water from an upstream location (such as pump 220) into a vessel into which the distributor assembly is mounted (such as vessel 210). As further illustrated in FIGS. 6-7, water travels through inlet manifold 110 by way of an inlet portion 112 at the bottom of distributor 100 and up through a riser section 114. Riser section 114, as depicted, is formed as a tubular member, and at a downstream end thereof is connected to a distributor face 116 that is provided with a plurality of circumferentially spaced exit orifices 118 that are adapted and configured to direct water outwardly in a generally radial direction into the tank as depicted in FIG. 1(c).

Distributor assembly 100 is further provided with a water outlet manifold 120 adapted and configured to direct water from the vessel 210 to a downstream location (such as a home, office or other location where treated water is desired). As depicted, outlet manifold 120 is formed concentrically about riser portion 114 of inlet manifold and includes a flow passage 122 defined by an outer surface of riser portion 114 and an inner surface of outer tubular member 124.

As further embodied herein, distributor assembly 100 is preferably provided with a drain 130. Drain 130 is used to periodically flush precipitate accumulated from the treatment of water. Drain 130 includes drain passages 132 formed into distributor assembly 100 that are in fluid communication with a drain outlet 134. In addition, a raw water outlet 140 can also be provided in distributor assembly 110 in fluid communication with inlet portion 112 of inlet manifold 110 to provide untreated water to a downstream location, such as an irrigation system or other application for untreated water. Drain outlet 134 and raw water outlet 140 are represented schematically in FIG. 1(c) for purposes of illustration, but as embodied herein are preferably actually integrated into distributor assembly 100 as depicted in FIGS. 2-5.

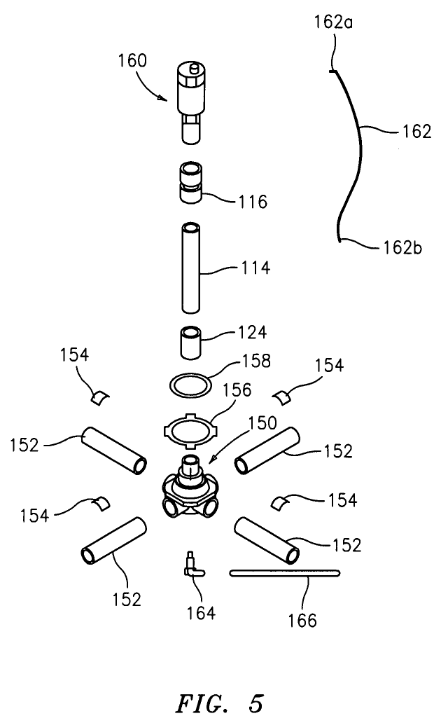

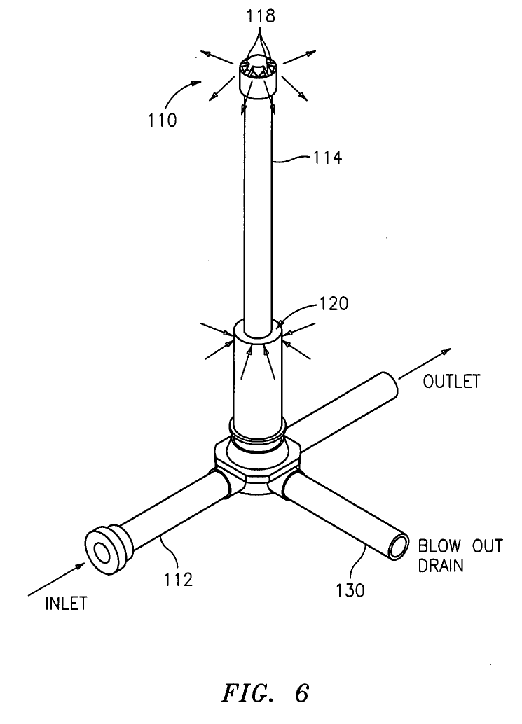

As depicted in detail in FIGS. 2-5, distributor assembly 100 includes a plurality of pipe sections 152 that are received by a hub portion 150 of distributor assembly 100. Hub portion 150 is preferably an injection molded plastic unit that includes inputs and outputs for inlet manifold 110, outlet manifold 120 and drain 130, as well as permitting direct flow from the raw water inlet (that feeds inlet manifold 110) to the raw water outlet 140. As further depicted in FIG. 5, distributor assembly also includes a tank seal 158 and tank seal retainer 156 for providing a fluid tight seal between tank 210 and distributor 100. In addition, an embodiment of an air control valve assembly 160 is also presented, discussed in detail below. Distributor assembly 100 can be made from a variety of materials, including for example polyvinyl chloride (“PVC”), chlorinated polyvinyl chloride (“CPVC”) and polyethylene (“PE”).

In further accordance with the invention, the distributor assembly is further provided with an air volume control valve.

For purposes of illustration and not limitation, as embodied herein and as depicted, for example, in FIGS. 1(c) and 2-5, and air volume control valve 160 is provided. Air volume control valve is preferably similar in structure and operation to that depicted in U.S. Pat. No. 6,481,456, which has been incorporated by reference herein above. As depicted herein, the air volume control valve 160 has a single air line 162 attached thereto at a first end 162a that is routed out of the tank 210 through distribution assembly 100 by way of a coupling 164 fitted into the bottom of distributor assembly 100. A second end 162b of air line 162 is affixed to a first portion of fitting 164 inside distributor assembly 100, and an external vent line 166 is affixed to a second portion of fitting 164 outside of distributor assembly 100. While it is possible to also affix a pressure reference line to air volume control valve 160 to control the pump 220 in system 200 as described in U.S. Pat. No. 6,481,456, since the air volume control valve 160 is inside tank 210 instead of outside the tank, it is preferable to simply route a pressure line 167 to trip the pump 220 from a pressure tap 169 situated elsewhere in the system 100, such as tank 210 or in a flow line proximate the inductor 230 or in the inductor itself.

As described in the patents incorporated by reference herein, air volume control valve 160 is adapted and configured to maintain a predetermined pressure range in the tank 210. Preferably, when the water level in the tank drops to a level below the lower inlet 165 of valve 160 (such as level 190), air rushes out through vent line 166 and the pressure in tank 210 drops. The pump 210 senses the pressure drop via line 167, and is then activated via at a predetermined pressure (via a mechanical switch or other controller) and pumps water into tank 210. As the water level rises in tank, the opening 165 into valve becomes flooded, and the flow of air through vent line decreases, and the air pressure in the tank above valve 160 rises, causing the water level inside the tubular riser portion 163 of valve 160 to rise more quickly than in the tank. When the water level reaches the level of float 168, float 168 rises, and eventually blocks off vent line 166. The pressure continues to rise in tank 210 until an upper pressure limit is reached, at which point pump 220 shuts off and the water in tank 210 achieves an upper level (such as 192). The period of time between cycles of pump can be increased, for example, by increasing the distance of valve inlet 165 from the top of tank 210, as described more fully in the patents incorporated by reference herein.

It will be appreciated that the distributor assembly described herein can be applied in a variety of applications and contexts, and may be made in a variety of sizes and from a variety of materials, depending on the application. Likewise, the height dimensions of distributor assembly 100 will vary depending on the dimensions and displacement of the tank. For example, for a tank 210 of approximately forty gallon displacement as depicted in FIG. 1, the exits of the intake manifold 110 are about 12 inches above the bottom of the tank. However, the length of riser pipe 114 can be extended to accommodate larger tank sizes (such as a 120 gallon tank).

The methods and systems of the present invention, as described above and shown in the drawings, provide for a superior distributor assembly and water treatment system that represents an advance over the prior art. It will be apparent to those skilled in the art that various modifications and variations can be made in the device and method of the present invention without departing from the spirit or scope of the invention. Thus, it is intended that the present invention include modifications and variations that are within the scope of the appended claims and their equivalents.

What is claimed is:

1. A fluid distributor assembly for a pressure vessel, comprising:
a) a water inlet manifold adapted and configured to direct water from an upstream location into a vessel into which the distributor assembly is mounted;
b) a water outlet manifold adapted and configured to direct water from the vessel to a downstream location; and
c) an air volume control valve adapted and configured to maintain a predetermined pressure range in the vessel.

2. The fluid distributor assembly of claim 1, wherein the distributor assembly is adapted and configured to be mounted through the bottom of a pressure vessel.

3. The fluid distributor assembly of claim 1, wherein the air volume control valve includes a vent line adapted and configured to direct vented air from the air volume control assembly out through the distributor.

4. The fluid distributor assembly of claim 1, wherein the water outlet manifold includes a first output for directing potable water to a first downstream location.

5. The fluid distributor assembly of claim 4, further comprising a drain line in fluid communication with the water outlet manifold.

6. The fluid distributor assembly of claim 1, wherein the water inlet manifold includes an output line for directing untreated water to an irrigation system.

7. The fluid distributor assembly of claim 1, wherein the air volume control assembly is adapted and configured to control the water level in the tank.

8. The fluid distributor assembly of claim 7, wherein the air volume control assembly is adapted and configured to control the water level in the tank between a low level setpoint and a high level setpoint.

9. A water treatment system, comprising:
a) a pressure vessel adapted and configured to hold a predetermined volume of fluid; and
b) a fluid distribution assembly disposed at a lower end of the pressure vessel, the fluid distribution assembly including:
i) a water inlet manifold adapted and configured to direct water from an upstream location into a vessel that the distributor assembly is mounted into;
ii) a water outlet manifold adapted and configured to direct water from the vessel to a downstream location; and
iii) an air volume control valve adapted and configured to maintain a predetermined pressure range in the vessel.

10. The system of claim 9, wherein the pressure vessel includes a plastic tank with a reinforcing layer disposed about the periphery of the plastic tank.

11. The system of claim 9, further comprising a pump upstream of and in fluid communication with the water inlet manifold, the pump being adapted and configured to pressurize a feed water stream delivered to the water inlet manifold.

12. The system of claim 11, further comprising an air inductor upstream of and in fluid communication with the water inlet manifold and downstream of and in fluid communication with the pump, the air inductor being adapted and configured to entrain air into water passing through the inductor.

13. The system of claim 9, wherein the air volume control valve includes a vent line adapted and configured to direct vented air from the air volume control assembly out of the vessel through the distributor.

14. The system of claim 9, wherein the water outlet manifold includes a first output for directing potable water to a first downstream location.

15. The system of claim 14, further comprising a drain line in fluid communication with the water outlet manifold.

16. The system of claim 9, wherein the water inlet manifold includes an output line for directing untreated water to an irrigation system.

17. The system of claim 9, wherein the air volume control assembly is adapted and configured to control the water level in the tank.

18. The system of claim 17, wherein the air volume control assembly is adapted and configured to control the water level in the tank between a low level setpoint and a high level setpoint.

19. A method of treating a fluid stream in a pressure vessel, comprising:
a) introducing water into the pressure vessel by way of a water inlet manifold;
b) evacuating treated water from the pressure through a water outlet manifold; and
c) maintaining a predetermined pressure range in the vessel using an air volume control valve, wherein all fluids are directed into and out of the pressure vessel through the bottom of the pressure vessel.
